(19) United States
(12) Patent Application Publication
(10) Pub. No.: US 2021/0105327 A1
(43) Pub. Date: Apr. 8, 2021

(54) SYSTEM, DEVICE AND METHOD FOR DIGITAL CONTENT SHARING USING A DYNAMIC LINK

(71) Applicant: S.G.A. INNOVATIONS LTD., Beer Sheva (IL)

(72) Inventors: Yuval SHTENDEL, Lehavim (IL); Shmuel GAL, Kibbutz Bet Kama (IL); Gal HARLEV, Moshav Nir Banim (IL); Alexey TSIRLIN, Beer Sheva (IL); Ronit SHTENDEL, Lehavim (IL); Noa SHTENDEL, Lehavim (IL)

(21) Appl. No.: 17/041,243

(22) PCT Filed: Mar. 28, 2020
(86) PCT No.: PCT/IL2019/050364

§ 371 Date: Sep. 24, 2020

Related U.S. Application Data
(60) Provisional application No. 62/649,591, filed on Mar. 29, 2018.

(51) Int. Cl. H04L 29/08; G06F 16/958; G06F 16/955; G06K 7/14; G06K 7/10

(52) U.S. Cl. CPC H04L 67/146; G06F 16/958; G06K 7/10297; G06K 7/1413; G06K 7/1417; G06F 16/9554

(57) ABSTRACT

The present invention provides systems, devices and methods for sharing a digital content using a dynamic link. More specifically, the systems, devices and methods enable to share a digital content that is linked to a code in a dynamic way.

### FIELD OF THE INVENTION

The invention relates to the field of digital content sharing. More specifically, the invention enables to share a digital content that is linked to a code in a dynamic way.

### BACKGROUND

Currently, users share digital content in several ways, usually using one of many applications, such as chat, e-mail, URL, etc. The digital content is constant without any “view/hear dependencies”. In other words, once a digital content is shared, the content is fixed and the recipient will get the digital content anywhere, at any time and will always get the same content.

There is thus a need in the art for improved and more flexible methods that enable enhanced digital content sharing with broader range of view/hear dependencies.

### SUMMARY OF THE INVENTION

The present invention, in embodiments thereof, provides systems, devices and methods that can advantageously allow dynamically linking a digital content to a designated code (such as bar code, QR Code, NFC tag, or the like).

In some embodiments, the present invention provides methods, devices, and systems to enable dynamic sharing of digital content (such as, text messages, and/or files, images, pictures, documents, audio files, music files, video files, and the like) by linking it to a designated code, using suitable devices (such as smartphone, tablet, computer, laptops, etc.), connected to a global database and server.

In some embodiments, the dynamic link may be determined by one or more parameters (attributes), such as: users' ID and profile, time, geographical locations, spatio-temporal distribution, and the like, or any combination thereof.

According to some embodiments, the disclosed methods, devices and systems are advantageous as they allow or have the ability to use a single designated code to dynamically lead to multiple digital content, based on specific parameters (attributes).

In some embodiments the disclosed methods, devices and systems can allow, or have the ability to, for example, set a specific time frame in which the dynamic link is valid/invalid; set expiration time after which the dynamic link is not valid; set activation time before which the dynamic link is not valid; assign to the dynamic link different digital content at different times; set a location at which the dynamic link is valid/invalid; assign to the dynamic link different digital content at different locations; limit the number of times the dynamic link can be followed; assign to the dynamic link different digital content depending on the number of times that the dynamic link has been followed; limit the number of followers that can follow the dynamic link; assign to the dynamic link different digital content depending on the number of different followers that followed the dynamic link; set follower list for which the dynamic link is valid/invalid; assign to the dynamic link different digital content depending on the follower ID and/or profile; set “group follow” mode (where the dynamic link is valid only when followers follow the dynamic link at the same time frame and/or at the same location, or any combination thereof.

According to some embodiments, there is provided a method for dynamic sharing of a digital content, the method include one or more of: creating a dynamic link by linking a digital content to a code; adding one or more specific attributes to the dynamic link, to enable the dynamic sharing of the digital content that is associated with the dynamic link, such that the dynamic sharing is based on the specific attributes of the dynamic link.

According to some embodiments, the specific attributes may be selected from: time, location, follow counter, users counter, follower user ID and/or profile, group follow mode and any combination thereof.

In some embodiments, the time attribute may include such attributes as, a specific time frame in which the dynamic link is valid/invalid, expiration time after which the dynamic link in not valid, activation time before which the dynamic link in not valid, assignment of different digital content to the dynamic link, at different times, or any combination thereof.

In some embodiments, the location attributes may include such attributes as: a geographical location at which the dynamic link is valid/invalid, assignment of different digital content to the dynamic link at different geographical locations, or any combination thereof.

In some embodiments, the follow counter attributes may include such attributes as: number of times the dynamic link can be followed, assignment of different digital content to the dynamic link at different follow counter values, or any combination thereof.

In some embodiments, the user(s) counter attributes may include such attributes as: number of users that can follow the dynamic link, assignment of different digital content to the dynamic link at different users counter value, or any combination thereof.

In some embodiments, the user ID and/or profile attributes may include such attributes as: users' ID list for which the dynamic link is valid/invalid, users' profile list for which the dynamic link is valid/invalid, assignment of different digital content to the dynamic link based on the user's ID, assignment of different digital content to the dynamic link based on the user's profile, or any combination thereof.

In some embodiments, the group follow mode allows validation of the dynamic link when followers acquire the code at the same time frame and/or at the same location.

In some embodiments, the code value may be acquired by scanning or reading one or more of: a barcode, a QR code and/or an NFC tag.

In some embodiments, the code value may be manually acquired, for example, by typing or copying of a set of characters.

In some embodiments, the digital content may include such content as: text messages, images, documents, audio files, video files, or any combination thereof.

In some embodiments, the link attributes may be updated or changed by the link creator at will.

In some embodiments, the method for dynamic sharing of a digital content may further include a step of registration. In some embodiments, the registration step may include providing user details.

In some embodiments, the method for dynamic sharing of a digital content may further include following a dynamic link by a follower, based on the code value and the one or more attributes of the dynamic link. In some embodiments, following a dynamic link may include viewing and/or hearing the digital content.

In some embodiments, the method may be executed on a communication device including one or more of: a processor, a transmitting unit, a receiving unit, a display unit, an input unit, a graphical user interface (GUI), location service mechanism, or combinations thereof. In some embodiments, the communication device may be a portable device.

According to some embodiments, there is provided a device for dynamic sharing of digital content, the device may include one or more of: a processor, a transmitting unit, a receiving unit, a display unit, an input unit, a graphical user interface (GUI), location service mechanism, or combinations thereof, the device is capable of executing a method for dynamic sharing of the digital content, the method comprising creating a dynamic link by linking a digital content to a code value and adding one or more specific attributes to the dynamic link, to enable the dynamic sharing of the digital content that is associated with the dynamic link, such that the sharing is based on the specific attributes of the dynamic link.

In some embodiments, the one or more attributes are selected from: time, location, follow counter, users counter, follower user ID and/or profile, group follow mode and any combination thereof.

In some embodiments, the code value may be acquired using the communication device. In some embodiments, the device may be capable of or be configured to allow scanning, reading and/or manually inputting a code. In some embodiments, the code may be selected from: a barcode, a Quick Response (QR) code, a Near Field Communication (NFC) tag, a set of characters, or any combination thereof. In some embodiments, the device may be a smartphone.

According to some embodiments there is provided a system for digital content sharing using a dynamic link, the system may include: a communicating device; a designated code; and local executable instructions that when executed on the communicating device can allow dynamic digital content sharing.

In some embodiments, the system may further include global server(s) and/or database.

In some embodiments, the local executable instructions may include: creating a dynamic link by linking a digital content to a code value; and adding one or more specific attributes to the dynamic link, to enable the dynamic sharing of the digital content that is associated with the dynamic link, such that the sharing is based on the specific attributes of the dynamic link.

In some embodiments, the code value may be acquired by scanning, reading and/or manually inputting the designated code. In some embodiments, the communication device is capable of allowing scanning, reading and/or manually inputting the designated code

In some embodiments, the designated code may be in a form selected from: a barcode, a quick response (QR) code, a Near Field Communication (NFC) tag, a set of characters, or any combination thereof. In some embodiments, the designated code may be in the form of NFC and/or QR code.

In some embodiments, the dynamic sharing may include: creating a dynamic link by linking a digital content to a code; adding one or more specific attributes to the dynamic link, to enable the dynamic sharing of the digital content that is associated with the dynamic link, such that the dynamic sharing is based on the specific attributes of the dynamic link.

Further embodiments, features, advantages and the full scope of applicability of the present invention will become apparent from the detailed description and drawings given hereinafter. However, it should be understood that the detailed description, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

Some embodiments of the invention are described herein with reference to the accompanying FIGS. The description, together with the FIGS. makes apparent to a person having ordinary skill in the art how some embodiments may be practiced. The FIGS. are for the purpose of illustrative description and no attempt is made to show structural details of an embodiment in more detail than is necessary for a fundamental understanding of the invention. For the sake of clarity, some objects depicted in the FIGS. are not to scale.

FIG. 1 Illustration of a method for digital content sharing using a dynamic link, according to some embodiments;

FIG. 2 Illustration of a block diagram of a device for digital content sharing using a dynamic link, according to some embodiments; and

FIG. 3 Illustration of a block diagram of a system for digital content sharing using a dynamic link, according to some embodiments.

### DETAILED DESCRIPTION OF THE INVENTION

The present invention, in embodiments thereof, provides systems, devices and methods that allow dynamic linking of a digital content to a designated code.

To facilitate understating, the following terms are defined:

As used herein, the term “code” refers to a representation of a value, which contain a string of bytes. Such representation can be in form of, for example, RF-ID such as Near Field Communication (NFC) tag, barcode, Quick Response (QR) code, characters, and the like. The value of the code (“code value”) can be obtained by, for example, scanning, reading, manually typing, copying, and the like, depending on the code representation. For example, a code in the form of a QR code can be scanned or read. For example, a code in the form of NFC can be read or scanned. For example, a character code can be received via email, messenger applications (such as, WhatsApp, Viber), and the like.

As used herein, the term “link creator” refers to a user that sets (creates) a dynamic link.

As used herein, the term “link follower(s)” refers to user(s) that follow(s) a dynamic link.

As used herein, the term “user profile” refers to the user's personal information, such as, for example, but not limited to: age, gender, occupation, hobbies, marital status, and the like.

According to some embodiments, there is provided a method for digital content sharing using a dynamic link, the method comprising creating and/or following a dynamic link, said dynamic link comprises various attributes, wherein the digital content linked to the dynamic link depends on those attributes.

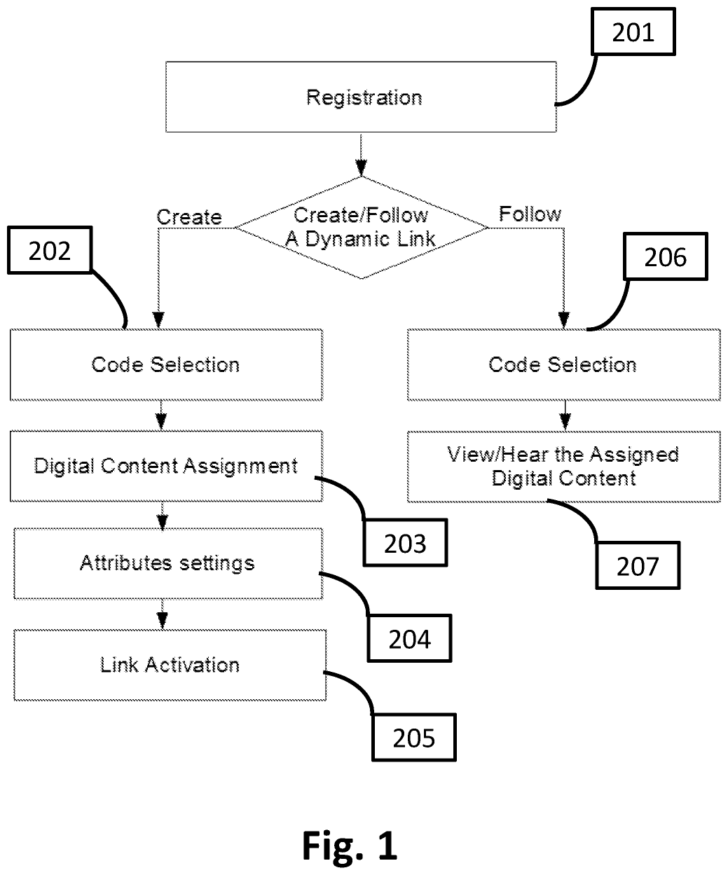

Reference is now made to FIG. 1, which illustrates steps in the methods of the present disclosure, according to some embodiments. At step 201, registration of a user is performed. Next, when creating a dynamic link, at the first step (shown as step 202), a code value is acquired by a user (“link creator”). The code value may be acquired (selected), by, for example, reading or scanning an NFC tag or QR code, manual typing of a code, and the like. Next, at step 203, a selected digital content is assigned to or associated with the code value to create a dynamic link. At step 204, one or more additional attributes may be added to the dynamic link. At step 205, the dynamic link is activated, such that it can be followed by other users (“link follower(s)”). In some embodiments, only after the dynamic link is activated, the link may be valid (depending on the link attributes). Next, for a link-follower to follow the activated dynamic link, step 206, the code value is acquired by the follower, (for example by scanning an NFC or QR code). At step 207, the follower can view/hear the assigned digital content, based on the specific attributes of the dynamic link.

In some embodiments, the same code can direct followers to different digital content, as determined by the dynamic link's attributes.

The embodiments presented below provide an exemplary description of various functions supported/executed by the methods disclosed herein and their implementation in the suitable devices and systems.

According to some embodiments, the method for digital content sharing using a dynamic link, may include one or more of the steps of:

i. Registration;

ii. Creation of a dynamic link:
a. Code selection;
b. Digital content selection;
c. Dynamic link attribute(s) settings;
d. Link activation;
   and/or

iii. Following a link:
a. Code selection; and/or
b. Viewing/hearing the dynamic link's digital content, based on the link attributes.

### Registration

In some embodiments, the registration step may be performed after the local application is installed on the communicating device (for example, a smartphone, laptop, tablet, and the like). In some embodiments, the registration step may include providing user details such as, for example, user name, address, phone number, etc. The registered phone number may be validated by means known in the art, for example, by sending an SMS to the phone. The user's record in the database can include one or more of the following fields: Phone number, name, address, user profile (such as: age, gender, occupation, hobbies, etc.), record creation date, record validity, and the like, or any combination thereof. Each possibility is a separate embodiment.

In some embodiments, the user's record in the database can be updated at will.

### Creating a Dynamic Link

The following steps disclose how a new dynamic link may be created, according to some embodiments. According to some embodiments, the steps may be executed at any desirable order and may include one or more of the steps of:

Code Value Acquiring (Selection)

In some embodiments, the code value selection may be performed by scanning or reading of, for example, an NFC or QR code. In some embodiments, the code value selection may be performed by manual typing of the code value. In some embodiments, the code value selection may be performed by or copying the code value, for example, when received via external source, such as, email, messenger, chat application, and the like.

Digital Content Assignment

In some embodiments, the link creator may assign digital content (such as, text messages, files, images, pictures, documents, audio files, music files, video files, and the like) to the dynamic link. In some embodiments, more than one message/file can be assigned to the same dynamic link, depending on the dynamic link's attributes.

Attributes Settings

In some embodiments, the link creator may set various attributes to the dynamic link. In some embodiments, the dynamic link is based on combination of one or more attributes. For example, any of the following attributes, or combinations thereof may be used:

Time Dependency Attributes:
Set a specific time frame in which the dynamic link is valid/invalid.
Set expiration time after which the dynamic link in not valid.
Set activation time before which the dynamic link in not valid.
Assign to the dynamic link different digital content at different times.

Location Dependency Attributes:
Set a geographical location at which the dynamic link is valid/invalid.
Assign to the dynamic link different digital content at different geographical locations.

Follow Counter Dependency Attributes:

In some embodiments, the follow counter counts the number of times that a dynamic link has been followed, and may be used, for example, to:
Limit the number of times the dynamic link can be followed.
Assign to the dynamic link different digital content at different follow counter values (for example, but not limited to: one content at follow counter values 1 to N and another content at follow counter values N+1 and up).
Allow each user to follow the dynamic link only once

User(s) Counter Dependency Attributes:
Limit the number of users that can follow the dynamic link.
Assign different contents at different users counter value (for example but not limited to: one content at users counter values 1 to N and another content at users counter values N+1 and up).

User's ID and/or Profile Dependency Attributes:
Set users' ID list for which the dynamic link is valid/invalid.
Set users' profile list (such as: age, gender, occupation, hobbies, etc′) for which the dynamic link is valid/invalid.
Assign to the dynamic link different digital content depending on the user's ID.
Assign to the dynamic link different digital content depending on the user's Profile.

Group Follow Dependency Attributes:

In some embodiments, the dynamic link may be valid only when followers follow the dynamic link at the same time frame and/or at the same location. In some embodiments, the dynamic link may be valid only when pre-defined followers follow the dynamic link at the same time frame and/or at the same location. In some embodiments dynamic link may be valid only when a predefined number of followers follow the dynamic link at the same time frame and/or at the same location. In some embodiments, the dynamic link may be valid only when a predefined number of predefined followers follow the dynamic link at the same time frame and/or at the same location.

Link Activation

According to some embodiments, the link may be activated by the link creator. In some embodiments, only after the link creator has activated the dynamic link the followers can follow (access) the link.

In some embodiments, the attributes may be updated or changed by the link creator at will.

### Following a Dynamic Link

In some embodiments, the digital content may be determined according to the dynamic link's attribute settings.

In some embodiments, the dynamic link may be followed according to one or more of the following steps:

Code Value Acquiring (Selection)

In some embodiments, the code value selection may be performed by scanning/reading of a suitable code (such as, for example, an NFC tag, QR code, and the like) and/or by manual input of the code value (for example, by typing a string of characters).

View/Hear Digital Content

In some embodiments the user that follows a dynamic link (follower) can view/hear the assigned digital content, based on the specific attributes of the dynamic link. According to some embodiments, the view/hear step includes parsing the dynamic link's attributes.

In some embodiments, the attributes may be selected from, but not limited to: time dependency, location dependency, follow counter dependency, user counter dependency, user ID and profile dependency, group follow dependency, or any combination thereof. Each possibility is a separate embodiment.

In some embodiments, the time dependency attributes may be selected from, but not limited to: specific time frame in which the dynamic link is valid/invalid, expiration time after which the dynamic link in not valid, activation time before which the dynamic link in not valid, dynamic link different digital content at different times, or any combination thereof. Each possibility is a separate embodiment.

In some embodiments, the location dependency attributes may be selected from, but not limited to: a geographical location at which the dynamic link is valid/invalid, assigning to the dynamic link different digital content at different geographical locations, or both. Each possibility is a separate embodiment.

In some embodiments, the follow counter dependency attributes may be selected from, but not limited to: Limit the number of times the dynamic link can be followed, assign to the dynamic link different digital content at different follow counter values, allow each user to follow the dynamic link only once, or any combination thereof. Each possibility is a separate embodiment.

In some embodiments, the user(s) counter dependency attributes may be selected from, but not limited to: Limit the number of users that can follow the dynamic link, assign different contents at different users counter value, or both. Each possibility is a separate embodiment.

In some embodiments, the user's ID and/or profile dependency attributes may be selected from, but not limited to: Set users' ID list for which the dynamic link is valid/invalid, set users' profile list for which the dynamic link is valid/invalid, set users' ID list for which the dynamic link is valid/invalid, set users' profile list for which the dynamic link is valid/invalid, assign to the dynamic link different digital content depending on the user's ID, assign to the dynamic link different digital content depending on the user's profile, assign to the dynamic link different digital content depending on the user's ID, assign to the dynamic link different digital content depending on the user's profile, or any combination thereof. Each possibility is a separate embodiment.

In some embodiments, the dynamic link may be valid only when followers follow the dynamic link at the same time frame and/or at the same location.

In some embodiments, the sharing of the digital content can be made to one or more followers or group of followers.

In some embodiments, the methods of the invention may be implemented as local executable instructions (such as in the form of an application), installed and executed on a communication device (such as smartphone), which may be utilized by an end user. In some embodiments for the method to be executed, a global database (DB) and/or server that supports multiplicity of end users may also be utilized.

According to some embodiments, there is provided a method for sharing a digital content, the method comprising a digital content, and a smart link code, said smart link code enables sharing of the content.

According to some embodiments, there is provided a communication device capable of executing a method for digital content sharing using a dynamic link. In some embodiments, the method executed on the device is implemented in the form of local executable instructions.

According to some embodiments, the communication device may include one or more of: a processor, a transmitting unit, a receiving unit, a display unit, an input unit, a graphical user interface (GUI), location service mechanism, NFC reader, QR scanner, or any combinations thereof. In some embodiments, an NFC reader and/or a QR scanner are part of the receiving unit of the device.

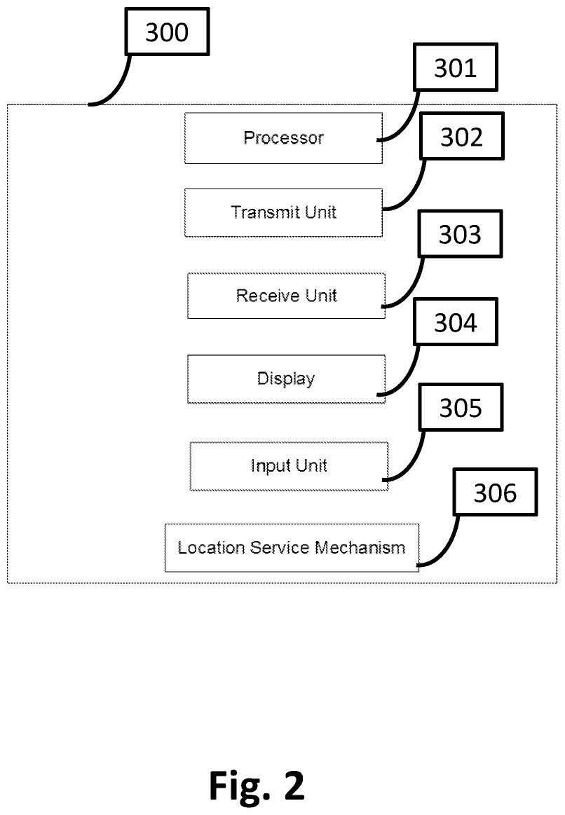

Reference is now made to FIG. 2, which illustrates a block diagram of a device for digital content sharing using a dynamic link, according to some embodiments. As shown in FIG. 2, communication device (300) can include one or more of: a processor (301), a transmitting unit (302), a receiving unit (303), a display unit (304) an input unit (305), a graphical user interface (GUI), location service mechanism (306), or combinations thereof, said device is capable of sharing a digital content using a dynamic link, according to some embodiments.

In some embodiments, the input unit of the device is capable of acquiring or allowing the acquiring of a code value, for example, by allowing scanning or reading of a code, such as, a QR code, bar-code, NFC tag, and the like, or any combination thereof. In some embodiments, the input unit is capable of acquiring or allowing the acquiring of a code value, by manually inputting (for example, typing or copying/pasting) a set of characters.

In some embodiments, the communication device is capable of executing a method for digital content sharing using a dynamic link, the method comprising creating and/or following a dynamic link, said dynamic link comprises various attributes, wherein the digital content linked to the dynamic link depends on those attributes. In some embodiments, the device has installed thereon local executable instructions, for example, in the form of an application, that when executed, allows digital content sharing between users, using a dynamic link.

According to some embodiments, there is provided a system for digital content sharing using a dynamic link, the system includes one or more of: a communicating device; a designated code; local executable instructions that when executed on the communicating device can allow dynamic digital content sharing; and optionally, global database and/or servers. Each possibility is a separate embodiment.

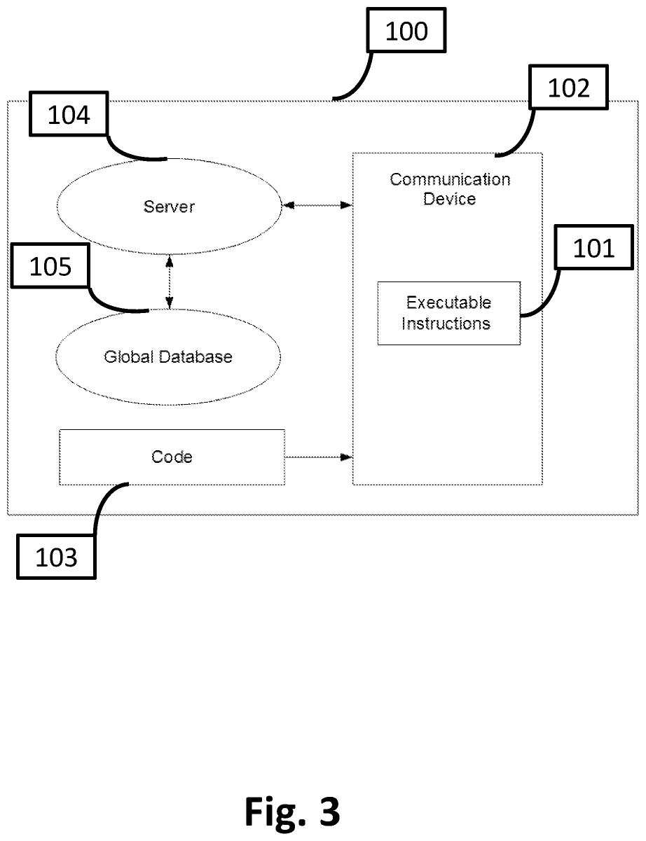

Reference is made to FIG. 3, which illustrates a system for digital content sharing using a dynamic link, according to some embodiments. As shown in FIG. 3, system (100) can include the following elements: a communication device (shown as communicating device 102), having installed thereon local executable instructions, (shown as executable instructions 101, for example, a local application) that when executed, allows digital content sharing between users, using a dynamic link. The dynamic link is associated to a code (103), wherein the code value affects the shared digital content. In some embodiments, the code can be in the form of QR code, NFC tag, barcode, RF-ID tag, manual code, set of characters, and the like. In some embodiments, the system may further include a global server (104) and database (105), which store and direct the digital content according to the dynamic link attributes.

According to some embodiments, there is provided a system for sharing of digital content using a dynamic link, the system may include one or more of: a communicating device, such as a portable communicating device; a designated code, for example, in the form of QR code or NFC tag; local executable instructions that when executed on the communicating device can allow dynamic digital content sharing, based on the value of the designated code and one or more attributes of the dynamic link; and global database and/or servers that can store, handle and/or direct the digital content to the followers.

According to some embodiments, the code may be is associated with or embedded within wearables, such as, clothing, watches, fitness trackers, hats, etc. According to some embodiments, the code may be in the form of special QR tattoos. According to some exemplary embodiments, the NFC tag or QR code may be associated with or embedded within wearables, such as, clothing, watches, fitness trackers, hats, etc. According to some embodiments, the QR code may be in the form of special QR tattoos.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1.-44. (canceled)

45. A method for dynamic sharing of a digital content, the method comprising:
a. creating a dynamic link by linking a digital content to a code; and
b. adding one or more specific attributes to the dynamic link, to enable the dynamic sharing of the digital content that is associated with the dynamic link, such that the dynamic sharing is based on the specific attributes of the dynamic link.

46. The method of claim 45, wherein the specific attribute is selected from: time, location, follow counter, users counter, follower user ID and/or profile, group follow mode and any combination thereof.

47. The method of claim 46, wherein the group follow mode attribute comprises validation of the dynamic link when followers acquire the code at the same time frame and/or at the same location.

48. The method of claim 46, wherein the time attribute comprises: a specific time frame in which the dynamic link is valid/invalid, expiration time after which the dynamic link in not valid, activation time before which the dynamic link in not valid, assignment of different digital content to the dynamic link, at different times, or any combination thereof and/or wherein the location attribute comprises: a geographical location at which the dynamic link is valid/invalid, assignment of different digital content to the dynamic link at different geographical locations, or any combination thereof.

49. The method of claim 46, wherein the follow counter attribute comprises: number of times the dynamic link can be followed, assignment of different digital content to the dynamic link at different follow counter values, or any combination thereof, and/or wherein the user(s) counter attribute comprises: number of users that can follow the dynamic link, assignment of different digital content to the dynamic link at different users counter value, or any combination thereof.

50. The method of claim 46, wherein the user ID and/or profile attribute comprises: users' ID list for which the dynamic link is valid/invalid, users' profile list for which the dynamic link is valid/invalid, assignment of different digital content to the dynamic link based on the user's ID, assignment of different digital content to the dynamic link based on the user's profile, or any combination thereof.

51. The method of claim 45, wherein the code value is acquired by scanning or reading one or more of: a barcode, a QR code and/or a Near Field Communication (NFC) tag, and/or wherein the code value is acquired by typing or copying a set of characters.

52. The method of claim 45, wherein the digital content comprises: text messages, images, documents, audio files, video files, or any combination thereof.

53. The method of claim 45, further comprising a step of registration, wherein the registration step comprises providing user details.

54. The method of claim 45, further comprising following a dynamic link by a follower, based on the code value and the one or more attributes of the dynamic link, wherein following a dynamic link comprises viewing and/or hearing the digital content.

55. The method of claim 45, wherein the method is executed on a communication device comprising one or more of: a processor, a transmitting unit, a receiving unit, a display unit, an input unit, a graphical user interface (GUI), location service mechanism, or combinations thereof.

56. A system for digital content sharing using a dynamic link, the system comprises: a communicating device, said communication device comprises one or more of: a processor, a transmitting unit, a receiving unit, a display unit, an input unit, a graphical user interface (GUI), location service mechanism;
a designated code; and
local executable instructions that when executed on the communicating device allow dynamic digital content sharing, wherein the local executable instructions comprises: creating a dynamic link by linking a digital content to a code value; and adding one or more specific attributes to the dynamic link, to enable the dynamic sharing of the digital content that is associated with the dynamic link, such that the sharing is based on the specific attributes of the dynamic link.

57. The system of claim 56, wherein the specific attribute is selected from: time, location, follow counter, users counter, follower user ID and/or profile, group follow mode and any combination thereof.

58. The system of claim 56, wherein the group follow mode attribute comprises validation of the dynamic link when followers acquire the code at the same time frame and/or at the same location.

59. The system of claim 56, wherein the code value is acquired by scanning, reading and/or manually inputting the designated code.

60. The system of claim 59, wherein the designated code is in a form selected from: a barcode, a quick response (QR) code, a Near Field Communication (NFC) tag, a set of characters, or any combination thereof.

61. The system of claim 56, wherein the system further comprises global server(s) and/or database.

62. The system of claim 56, wherein the time attribute comprises: a specific time frame in which the dynamic link is valid/invalid, expiration time after which the dynamic link in not valid, activation time before which the dynamic link in not valid, assignment of different digital content to the dynamic link, at different times, or any combination thereof and/or wherein the location attribute comprises: a geographical location at which the dynamic link is valid/invalid, assignment of different digital content to the dynamic link at different geographical locations, or any combination thereof.

63. The system of claim 56, wherein the follow counter attribute comprises: number of times the dynamic link can be followed, assignment of different digital content to the dynamic link at different follow counter values, or any combination thereof and/or wherein the user(s) counter attribute comprises: number of users that can follow the dynamic link, assignment of different digital content to the dynamic link at different users counter value, or any combination thereof.

64. The system of claim 56, wherein the user ID and/or profile attribute comprises: users' ID list for which the dynamic link is valid/invalid, users' profile list for which the dynamic link is valid/invalid, assignment of different digital content to the dynamic link based on the user's ID, assignment of different digital content to the dynamic link based on the user's profile, or any combination thereof.

65. The system of claim 56, wherein the code value is acquired using the communication device and/or wherein the communication device is capable of allowing scanning, reading and/or manually inputting the designated code.
